(19) United States
(12) Patent Application Publication
(10) Pub. No.: US 2010/0078516 A1
(43) Pub. Date: Apr. 1, 2010

(54) Faster Gyrodynes: Mach .88, or better

(76) Inventor: Joel Ginzberg, Rosendale, NY (US)

Correspondence Address: Joel Ginzberg, PO Box 7, High Falls, NY, 12440-0007, US

(21) Appl. No.: 12/240,443

(22) Filed: Sep. 29, 2008

(51) Int. Cl. B64C 27/02

(52) U.S. Cl. 244/17.11

(57) ABSTRACT

DARPA's Heliplane Program Manager, Don Woodbury indicated that they did not realize how much of a challenge 400 mph (cruise speed) was. The interviewer noted: “In their initial assessment of the hurdles posed by the Heliplane's requirements GBA considered, rotor head drag was believed to be the simplest to deal with. . . . opposite . . . true.” Faster Gyrodynes . . . allows planes to have both Lift/Drag ratios and speeds equal, or approaching, those of fixed wing planes while having the VTOL/hover capability of a gyrodyne. This is achieved by making the rotor and related components retractable which eliminates their drag. If retracted within the fuselage and the presence of door(s) does not add parasitic drag, the L/D ratio should be the same as an otherwise identical fixed wing craft. If an external pod is required its drag will reduce the L/D ratio to some extent,

Focus has been on the invention in context of its origin, the convertable fixed wing/gyrodyne hybrid. The essence of the invention, a retractable rotor for use when the need for rotor lift is intermittent, eliminates rotor related drag and can be applied wherever its meets a specific requirement.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of the Invention

The invention falls within the areas of aeronautics and astronautics. It relates to the fixed wing/powered-rotor-blade biplane hybrids, called gyrodynes. It applies to all intermittent uses of rotors.

2. Prior Art

In 1957 Fairey Aviation's “Eland” Rotodyne prototype successfully completed its maiden voyage. In 1958 it managed a cruise speed of 150 knots and in '59 it set a world speed record of 190.9 knots on a 100 km closed circuit. The Rotodyne was a biplane with one fixed and one rotor wing; a compound helicopter.

The rotor was powered for take off, hover and landing by rotor blade tip jets. Otherwise, the rotor was unpowered and rotor lift was reduced by half and the wing took up the slack. That resulted in the speeds mentioned above. Even though the craft was clearly successful, the project was scrapped because of a budget cutting decision by the British government to reduce the number of helicopter firms it supported. That resulted in the destruction of the “Eland” Rotodyne, its tooling and almost everything related to it in any way. That, in spite of the fact that it was the prototype of a unique landmark design in aviation history.

More recently Groen Brothers Aviation, which has done significant work improving gyroplanes (the FAA's name; or gyrocopters). They began to explore the developmental potential of the Rotodyne, calling it a gyrodyne. They built a craft to explore the notion by removing both engines from a Cessna Skymaster, replaced the front engine with a Rolls Royce model 250 gas turbine, removed the rear engine, put clamshell doors in its place, and inverted the booms supporting the tail structure. That provided clearance for the rotor blades when they added a rotor.

Their proposals to the Defense Advanced Research Projects Agency (DARPA) of gyrodyne designs to meet the Department of the Army's need for an Advanced Maneuver Transport with their proposal for the GBA Heavy Lift Gyrolifter and the VTOL Combat Search and Rescue craft (CSAR) constitute the most recent prior art. A cruise speed of 200-330 knots, a payload of 40,000 lb. and an unrefueled range of 500-1000 nm were proposed for the VTOL Gyrolifter, based on a modified C 130, as reported in Air International, June 2003. GBA was moved to lead role from a specific contracted task in the CSAR project; the gyrodyne which DARPA calls the Heliplane, is slated to achieve better than a twofold increase in performance, as compared with a conventional helicopter. A cruise speed 400 mph, an unrefueled range of 1,152 miles and a payload of 1000 lb. DARPA gave the GBA/Georgia Tech, Adams Aircraft et al team a contract to design and develop a proof-of-concept prototype. As Adams has declared bankruptcy, a substitute for the A 700 is necessary. The figures above are from the Aug. 17, 2006 GBA news release announcing that the CSAR team had reached its third milestone in the development of the modified Adams A 700 prototype.

### Better

When first reading GBA's discussion of Fairey's Rotodyne, the original fixed wing/tip jet-powered-rotor hybrid, their own exploratory work and their notion of developing a series of VTOL commuter aircraft with various seating capacities, I made a leap of fantasy and visualized a VTOL 747. My familiarity with the speed ranges of different types of aircraft and more careful reading bought me back down to earth.

GBA has pointed out that the gyrodyne technology is scalable and appropriate for commuter aircraft. Reviewing their proposed specifications and published comparisons of the Lift/Drag ratios of the gyrodynes (10+) to those of helicopters (5-6) and fixed wing planes (15+), as well as its potential use in commuter aircraft design, set me thinking. I considered the three types of craft in the abstract, as represented by their characteristic lift drag ratios, temporarily unencumbered by images of gyrodynes and the relative proportions of their parts. Given the hybrid nature of the gyrodyne, it was easy to imagine, in the abstract, switching back and forth between a Lift/Drag ratio of 10+ and 15+; a hybrid craft able to change rapidly from a gyrodyne to a fixed wing configuration. All that is required is to make the gyrodyne add-ons, rotor and related hardware, retractable. Conceiving of it occurred more rapidly than my attempt at description.

The DARPA Heliplane Program Manager, Don Woodbury, was quoted in Flight International, 19 Dec. 2006-1 Jan. 2007 as follows: “We did not realize how much of a challenge 400 mph was, but we have design that converges, and we've got some margin.” In their initial assessment of the hurdles posed by the Heliplane's requirements GBA considered, rotor head drag was believed to be the simplest to deal with. Just the opposite turned out to be true.

This discussion of prior art has been written relying solely on the descriptions in the GBA on-line technical material, news releases and the trade.

### Purposes and Advantages of the Invention

The two major issues raised in the Heliplane development program are achieving the goal of a 400 mph cruising speed and reducing rotor head drag. This invention eliminates these problems. Clearly, retracting the gyrodyne hardware removes the possibility of rotor head drag. Once the plane is in fixed wing mode, without that drag, why should a cruising speed of 400 mph be a problem? Logically, if one wants a fast long range plane with VTOL and hover capability; modify a Boeing 777 by adding a retractable rotor, with tip-jet powered blades. The purpose of Faster Gyrodynes . . . is just that, to allow building my imagined VTOL 747 or 777. Or generally, to make possible VTOL/hover-capable fixed wing aircraft which achieve sustained cruise speeds well beyond the target cruise speed for DARPA's Heliplane or GBA's conceptual VTOL commuter aircraft. Or generally, to allow intermittent use of rotor lift as needed, without incurring the drag losses associated with the rotor and its related structures, when the rotor lift can be dispensed with.

### Environmental Effects

The introduction of VTOL commuter aircraft could gradually lead to a reduction in the demand for airport slots, possibly limiting the need for new large airports. While clearly the existence of a growing fleet VTOL full size, long range fast transports would gradually make current large airports in the boondocks unnecessary. It can allow development of air terminals to accommodate them, suitable for vertical take off and landing, closer to the centers of populated areas. That would free up the acreage used for large airports for other purposes. Ground travel time for passengers would be cut drastically, if VTOL commuter and fast long range transports were widely chosen by carriers, and land transport system resources would be conserved.

### SUMMARY

The challenge is to design aircraft that can achieve speeds characteristic of fixed wing machines; while also being capable of vertical take off, landing and hover of the gyrodynes under development, or helicopters. My solution is simple. The plane will alternately be a fixed wing craft and a gyrodyne. So it will achieve high L/D ratios and speeds as a fixed wing plane and VTOL plus hover, as a gyrodyne. In other words, the gyrodyne structures are to be retractable; as are the landing gear of many planes or the engines of some motorized sailplanes, reducing drag.

So the only instructions that the patent need provide for a faster gyrodyne's design and construction are: To build a faster gyrodyne, make all the gyrodyne related hardware retractable. The pilot must be able to switch back and forth between the fixed wing and gyrodyne configurations of the aircraft with ease. Just integrate these requirements into the design.

### DETAILED DESCRIPTION

### Description Embodiment I

As just mentioned, my solution to designing high speed, long range, VTOL plus hover transports, is to make aircraft that can switch back and forth between the gyrodyne and the fixed wing configuration. I.e., all the gyrodyne components must be easily retractable and extendable.

### Delegation of the Design Details of the Retractable Gyrodyne to Any Engineering Team Competent in the Field:

As far I can see, specifying that the gyrodyne components must be designed and built to be routinely retractable and reextendable.

Therefore, what follows is intended solely to make this assertion plausible. For example, consider what kinds of changes would be required to be made to the modified C 130 gyrodyne design proposed to DARPA by the GBA, Georgia Tech, Lockheed Martin et al team, to meet requirements for a VTOL transport that has a Lift/Drag ratio and speed equal, or close, to that of the unmodified C 130. If the C 130 can become a retractable gyrodyne, so can a newly designed aircraft, or, possibly, some recent model transport. Although given the growing complexity of recent transports, there is likely to be a significant advantage to including the retraction/extension feature of the gyrodyne hardware in the initial, integrated design.

### Packing

The practical limiting factor on packing the retracted rotor components is in the relationship between the dimensions of the fuselage and the gyrodyne components. For example, the A 700 appears to provide a much greater challenge than a C 130. Changing a gyrodyne to make its rotor structures retractable, is a packing problem first and foremost but it can raise other issues. Any packing specification might well require modification in the structure of another system which may, or may not, be practical.

Ideally the gyrodyne components should retract completely within the fuselage, retaining the Lift/Drag ratio of the basic fixed wing design. In that case, the part of the top of the fuselage is replaced by doors. Of course, this will require attention to sealing the door to protect the pressure differential at altitude. When modifying an existing craft, it may well be more practical to add a pod to the top of the fuselage.

In order to retract the rotor blades they must become parallel, or almost so, to the longitudinal axis of the plane and they must move down, into the fuselage or pod, along with the mast and rotor head.

GBA has chosen to replace the vertical stabilizer of the C 130 with four smaller ones supported by the horizontal stabilizer in order to provide clearance for the rotor blades. The rotor blades appear to extend about two or three feet past the tail cone. A choice must be made between making room for the full length rotor blades, by extending the pod if one is used, or extending the tail cone itself. With respect to the prototype CSAR, which was to be a modified Adams A 700 light jet, it might be feasible to extend the central cockpit structure as a third boom or a pod to accommodate the retracted rotor head, blades and supporting structures.

But that assumes that no change is made in the length of the rotor blades. One might shorten the blades and increase their number. Or possibly add an additional rotor, or rotors, creating a bi, tri- or n-plane, by stacking one or more rotors. It does not seem probable that more than two rotors would be necessary to provide the required lift, but there might be other reasons for that choice. Clearly, that would complicate the packing problem. Another choice might be to fold the rotors. Some WW II USN carrier planes had folding wings, as do some light planes while at least some jet fighters have variable swept back wings.

If the rotor blades are folded, one issue that arises is the need to fold the planned fuel lines. Given the nature of the invention, the rotor airfoil contour controls that GBA has specified for their gyrodyne CSAR, may not be required. If the rotors are to be attached to a circular ring that is part of the rotor head in order that they can be slid into a trailing position, one will have to take into account the limiting width of the fuselage or pod. Given that choice, only one of the blades can be parallel to the longitudinal axis of the plane, and none to each other, unless special pains are taken.

If that presents a problem because of the length of the rotor blades and width of the enclosure, one could substitute a polygon with sides just long enough to accommodate a single rotor and necessary mechanisms. An n-sided polygon (n-gon) could be used to form a polygonal structure as part of the rotor head, although the choice of geometry depends on the specific application. Note that a side as a structural element corresponds directly with a geometrical side of the polygonal structure for those sides supporting a rotor blade. The structural elements which are only spacers include the angles necessary to form the n-gon and may include more than one geometric side of the polygon. The sides supporting rotor blade must meet the requirement that when the rotor blades are being retracted and their supporting sides butt against each other, the blades are automatically aligned in parallel, so that when the rotor blades are being retracted and their supporting sides butt against each other, the blades are automatically aligned in parallel. So the angles required to form the n-gon must be included in spacer structural components, which may including one, or more, of the spacer polygon sides which complete the structure.

When necessary to align the rotor blades in parallel, trailing to the rear, the spacer polygon sides would be moved out of the way and sides supporting rotor blades would be aligned and locked in place. Spacer sides likely required in most polygonal rotor heads should be tethered to a ring of smaller diameter. That would allow them to be pulled out of the way, so that sides supporting rotor blades can be properly positioned with the blades parallel to each other.

There is another possible way of dealing with aligning the rotor blades. If there were only two rotor blades they could be hinged, so that one or both of them, once stopped, parallel to the longitudinal axis of the craft, rotating the forward blade 180 degrees out of its path of rotation would leave it on top of the aft blade. This is simpler than a polygonal movable structure in the rotor head. For more than two rotor blades, it suggests the use of stacked rotors.

Of course, there must be mechanisms to move all the pieces into place and their flexing must also likely be managed, to allow their positioning and secure them as rotor parts or pack them away and allow the plane to revert to fixed wing status. These mechanisms must have a control system. This is a bit mechanically complex but it is not string theory. None of the packing problems or those they raise are beyond either the active CSAR team or the GBA Gyrolifter proposal team. In fact, I suspect that any aeronautical or astronautical engineering team would handle them quite well.

### Instructions for the Designer

Therefore, the only instructions that the patent need provide is: For faster Gyrodynes, make the gyrodyne hardware retractable. The pilot must be able to switch back and forth between fixed wing and gyrodyne configurations in the aircraft with ease. Just integrate these requirements into the design.

### Building One

The current development work for DARPA on the CSAR gyrodyne, their Heliplane, is aiming at a cruise speed of 400 mph and a Lift/Drag ratio of 10+. Fixed wing crafts' Lift/Drag ratios are in the 15+ range. If one could design and build a plane that could change its identity at will; i.e., switch back and forth between the gyrodyne and the fixed wing configuration, one would have the best of both worlds. Build the gyrodyne structures retractable. Done well, switching should be simple. So the patent states that to create a plane capable of VTOL and hover with a L/D significantly greater than 10+, even in the 15+ range of fixed wing aircraft, one builds a gyrodyne with all gyrodyne structures retractable; a ‘Flipper’?

Building a fixed wing/gyrodyne hybrid from scratch would allow development of a fully integrated design, avoiding compromises required when modifying an existing fixed wing aircraft already in production. Yet GBA's choosing to convert a C 130 into a gyrodyne in its Gyrolifter proposal was much less demanding of time and resources than starting from scratch. That is also likely to be true producing a retractable gyrodyne for the time being.

As far as I can see, the engineering methods required to build de novo or modify an existing plane into a fixed wing/gyrodyne hybrid are already in the aeronautical/astronautical engineering repertoire.

### Operation

### Vertical Take Off and Transition to Fixed Wing Mode:

The operation is analogous to the operation of retractable landing gear. If, when ready for take off the gyrodyne structures are not extended, extend them. Make a normal gyrodyne take off as prescribed by its designers. After reaching, or exceeding, a minimum altitude, and within the appropriate airspeed range, off load the rotor as in normal gyrodyne operation while accelerating, as necessary, with the main engines and propellers. At the appropriate point, kill the rotor power and stop the rotor. Proceed to retract the gyrodyne structures. You are now flying a fixed wing aircraft; proceed accordingly. All decision point criteria are to be established in flight testing.

### Back to Gyrodyne Mode

When one wishes to extend the rotor structures in flight and change to gyrodyne mode, reduce forward speed to the appropriate range for the operation. Extend the gyrodyne structures and unlock the rotor and gradually load and power it up as required. The craft is in gyrodyne mode.

Of course, all the procedures for transition between the gyrodyne and fixed wing modes will be reviewed, evaluated and finally specified during flight testing. The specific criteria for proceeding with any step in the process will be established at that time for that specific prototype.

### Ramifications

The possibility of folding the rotor blades has been mentioned above and examples mentioned of similar pilot controlled structural/functional changes to aircraft in flight. But current morphing aircraft research is exploring much more radical pilot initiated in flight structural/functional changes; e.g., someone is working on a pneumatic telescopic wing. (see the editorial, Introduction to Morphine Aircraft Research, G. Reich and B. Sanders and papers that follow it; Journal of Aircraft, July-August 2007, vol. 44, #4, pp. 1059-1099) This research may eventually make designing various gyrodyne craft simpler.

The invention grew out of an interest in bettering the performance of the Heliplane design and led to the hybrid fixed wing/gyrodyne by virtue of its ability to rapidly convert from one to the other; a flipper. Of course, the essence of the invention is the retraction and reextension of the rotor and its related structures.

Above, the invention's application has been limited to fixed wing, heavier than air craft. Its use is clearly appropriate in any design including a rotor, powered or not, requiring only intermittent use of rotor generated lift. So when rotor lift is not required, the invention allows one to dispense with the rotor structures' associated drag by eliminating their presence in the air stream.

Reading about landing sizable lighter than air craft and controlling them on the ground with, e.g., two tiltable engines, suggested that multiple retractable powered rotors probably would be a vast improvement. A computer controlled system would probably be best for larger craft.

As mentioned above, a gyrodyne can be described as a fixed wing aircraft to which is a added an independently powered rotor to provide VTOL and hover capabilities. Practice has been to add small jets to each rotor blade. In forward flight the rotor is unloaded with the angle of attack set to minimize rotor related drag which limits the top speed of the craft; e.g., the design speed for the CSAR is 400 mph.

Wherein the improvement consists of eliminating this limiting drag, by providing the ability to completely remove the drag creating rotor structures from contact with the relative wind. This is accomplished simply by making the rotor and all its related structures easily retractable and reextendable by the pilot in flight. This provides the pilot the ability to convert the craft from a gyrodyne to a fixed wing plane, and vica versa.

This hybrid fixed wing gyrodyne design provides the basis for designing planes with the performance of fixed wing jets with the vertical take off, landing and hover capabilities of a gyrodyne.

I claim:

1. A method of making a gyrodyne variant that has a higher Lift/Drag ratio and speed than gyrodynes currently proposed, or in development.
a) comprising a gyrodyne, design or aircraft and
b) means to facilitate retracting and reextending rotor and related structures; necessary required to change a fixed wing plane into a gyrodyne
c) functional means to choose the operating mode, gyrodyne or fixed wing; the retraction and extension mechanisms for the rotor and its supporting components
i) with the rotor in place, the craft is a typical gyrodyne with fixed wing plus hover, vertical take off and landing capabilities
ii) with the rotor retracted, the craft is functionally a fixed wing plane with a Lift/Drag ratio around 15, or more, and commensurate speed.
d) which provides the basis for designing high speed jet aircraft with VTOL and hover capabilities
